(19) United States
(12) Patent Application Publication
(10) Pub. No.: US 2013/0330560 A1
(43) Pub. Date: Dec. 12, 2013

(54) INTERMEDIATE TRANSFER MEMBER AND IMAGE FORMING APPARATUS INCLUDING THE SAME

(71) Applicant: Konica Minolta, Inc., Tokyo (JP)

(72) Inventors: Akihiro HONYA, Tokyo (US); Sadaaki SAKAMOTO, Tokyo (JP); Go YAMAGUCHI, Tokyo (JP)

(21) Appl. No.: 13/915,073

(22) Filed: Jun. 11, 2013

(30) Foreign Application Priority Data
Jun. 12, 2012 (JP) 2012-132840

(51) Int. Cl. B32B 9/04

(52) U.S. Cl. CPC G03G 15/1605
USPC 428/411.1

(57) ABSTRACT

An intermediate transfer member includes a substrate and a surface layer. The surface layer may be formed by exposure of UV of a coating film containing a curable composition and a metal oxide fine particle. The curable composition includes a polyorganosiloxane multifunctional vinyl copolymer and multifunctional (meth)acrylate. The multifunctional vinyl copolymer has a weight-average molecular weight of 5,000 to 100,000. The metal oxide fine particles include a polyorganosiloxane surface layer. The intermediate transfer member enables suppression of filming and is insusceptible to abrasion and scratches even in long-term use, has small surface energy, and is favorable for use in an electrophotographic image forming apparatus.

### CROSS REFERENCE TO RELATED APPLICATIONS

This application is entitled to and claims the benefit of Japanese Patent Application No. 2012-132840, filed on Jun. 12, 2012, the disclosure of which including the specification, drawings and abstract is incorporated herein by reference in its entirety.

### BACKGROUND OF THE INVENTION

1. Field of the Invention

The present invention relates to an intermediate transfer member and an image forming apparatus including the same.

2. Description of Related Art

Some of image forming apparatuses, that form an image formed of a plurality of types of toners, such as full-color image forming apparatuses include an intermediate transfer member. The intermediate transfer member receives toner images formed of the respective toners so as to overlap one another and transfers the images onto a recording medium such as plain paper. In general, toner images are repeatedly carried on and transferred from a surface of the intermediate transfer member. Therefore, the intermediate transfer member is configured so that the surface thereof has desired surface characteristics. Also, examples of the intermediate transfer member include a drum type intermediate transfer member and an endless belt type intermediate transfer member (hereinafter also referred to as “intermediate transfer belt”).

Conventionally, an intermediate transfer belt including a surface layer that includes a cured layer of a coating solution containing pentaerythritol hexaacrylate and conductive particles and has a predetermined surface roughness has been known (see, for example, Japanese Patent Application Laid-Open No. 2007-183401). Also, an intermediate transfer belt including a surface layer formed by curing a fluorine resin and fluorine rubber composition by means of a curing agent or a surface layer, in which surface free energy of the surface layer and a hardness of the surface layer when it is depressed, are specified as indexes for improving toner removal has been known (see, for example, Japanese Patent Application Laid-Open No. 2010-15143).

The former intermediate transfer belt easily generates a film of wax and/or an external additive in the toners are formed on the surface along with long-term use, what is called filming. The latter intermediate transfer belt has a low hardness and thus is susceptible to abrasion and scratches and also is difficult to clean by a blade.

The durability and electric characteristics of the surface of an intermediate transfer member can be provided by evenly dispersing inorganic particles such as conductive particles in the surface layer of the intermediate transfer member. Also, for example, a decrease in surface free energy of the surface of the intermediate transfer member is achieved by blending silicone components in resin components of a surface layer of the intermediate transfer member. However, the silicone components tend to be localized in the surface of the surface layer. Thus, only slight abrasion of the surface of the surface layer may largely impair the desired low surface free energy characteristic. Therefore, there is a demand for a technique that enables provision of desired surface characteristics of an intermediate transfer member whether the surface has been worn away.

An object of the present invention is to provide an intermediate transfer member that enabling suppression of filming and maintenance of low surface free energy even in long-term use.

### SUMMARY OF THE INVENTION

To achieve at least the above-mentioned object, an intermediate transfer member reflecting one aspect of the present invention comprises a substrate and a surface layer disposed on the substrate. The intermediate transfer member is used in an electrophotographic image forming apparatus. The surface layer is a cured coat of a coating solution for surface layer, the coating solution containing an actinic ray-curable composition and metal oxide fine particles, the coat cured by irradiation with an actinic ray. The actinic ray-curable composition contains: a vinyl copolymer with a weight-average molecular weight of 5,000 to 100,000, the vinyl copolymer including at least one polyorganosiloxane chain A and at least three radically-polymerizable double bonds; and a multifunctional (meth)acrylate. The metal oxide fine particles are surface-treated with a surface treating agent including a polyorganosiloxane chain B.

Also, another aspect of the present invention provides an image forming apparatus including the intermediate transfer member.

### BRIEF DESCRIPTION OF DRAWINGS

The present invention will become more fully understood from the detailed description given hereinbelow and the appended drawings which are given by way of illustration only, and thus are not intended as a definition of the limits of the present invention, and wherein:

FIG. 1 is a diagram schematically illustrating an example configuration of a color image forming apparatus in which an intermediate transfer member according to the present invention is incorporated;

FIG. 2 is a partial enlarged view of a cross-sectional structure of an embodiment of an intermediate transfer member according to the present invention;

FIG. 3A is a diagram illustrating a manufacturing process for manufacturing an embodiment of an intermediate transfer member according to the present invention and FIG. 3B is a diagram schematically illustrating an coating apparatus used in the process; and

FIGS. 4A and 4B are diagrams schematically illustrating a surface layer curing apparatus used in a curing step in manufacture of an embodiment of an intermediate transfer member according to the present invention.

### DESCRIPTION OF THE PREFERRED EMBODIMENTS

1. Intermediate Transfer Member

An intermediate transfer member according to the present invention includes a substrate and a surface layer that covers a surface of the substrate. In other words, the intermediate transfer member includes a substrate and a surface layer formed thereon. The intermediate transfer member may further have a layer or no layer other than the substrate and the surface layer.

For the substrate, a substrate for a conventional intermediate transfer member can be used. Examples of the substrate include a sleeve having conductivity and an endless belt of a resin having conductivity and flexibility. Examples of the resin include heat resistant resins such as polyimide.

The surface layer forms a surface of the intermediate transfer member. The surface layer may be a layer directly covering a surface of the substrate or a layer covering a surface of the substrate across another layer. Here, examples of the other layer include a layer including an elastic material (elastic layer). The intermediate transfer member including an elastic layer is preferable from the perspective of enhancement of the degree of toner images on photoconductor surfaces contacting the surface of the intermediate transfer member. The elastic layer can include any of various elastic materials such as a resin having a foam structure and a resin having rubber elasticity; however, it is preferable that the elastic material include a material having elasticity from among the later-described surface layer materials, from the perspective of enhancement of adhesion between the elastic layer and the surface layer.

The surface layer will be described below.

The surface layer has a thickness that can arbitrarily be determined within a range in which desired characteristics of the surface layer can be provided, for example, 1 to 10 μm, preferably 1 to 5 μm. The thickness of the surface layer can be adjusted according to, for example, the concentration of a coating solution for surface layer formation (hereinafter also referred to as “surface coating material”), which will be described later, and/or the number of applications of the coating solution.

From the perspective of enhancement of filming resistance, toner transfer ratio and scratch resistance, a Si concentration of the surface layer at a depth of 2 to 5% relative to a total thickness of the surface layer from the surface of the surface layer is preferably 1 to 10%, more preferably 4 to 10%. The Si concentration can be measured by, for example, depth profiling using argon ions in electron spectroscopy for chemical analysis (ESCA). Also, the Si concentration can be adjusted by, for example, the content of a vinyl copolymer, which will be described later, in the surface coating material.

The surface layer is formed by irradiating a coating film (surface coating material film) of the surface coating material with an actinic ray. The surface coating material film can be formed by a method, conventionally used for formation of a surface coating material film in the substrate, such as immersion, spraying and coating. The actinic ray is an energy ray that cures an actinic ray-curable composition (hereinafter also referred to as “curable composition”), which will be described later, for example, an ultraviolet ray with a wavelength of 400 nm or shorter. The actinic ray is applied to the surface coating material film in an amount sufficient to cure the later-described curable composition.

The surface coating material contains a curable composition and metal oxide fine particles.

The curable composition contains a vinyl copolymer and a multifunctional (meth)acrylate. “(Meth)acrylate” is a common name of methacrylate and acrylate and refers to one or both of methacrylate and acrylate.

The vinyl copolymer has a weight-average molecular weight of 5,000 to 100,000. From the perspective of enhancement of compatibility of the vinyl copolymer in the curable composition, it is preferable that the weight-average molecular weight of the vinyl copolymer fall within the above range. If the weight-average molecular weight of the vinyl copolymer is smaller than 5,000, the vinyl copolymer is easily crystallized, which may result in substantial deterioration in productivity. If the weight-average molecular weight of the vinyl copolymer exceeds 100,000, the hardness of the surface layer is lowered, which may impair the functions of the intermediate transfer member.

The vinyl copolymer contains at least one polyorganosiloxane chain A and at least three radically-polymerizable double bonds. Such vinyl copolymer can be obtained by, for example, radically polymerizing below-indicated monomer (a) and below-indicated monomer (b), and as necessary below-indicated monomer (c) to obtain an intermediate copolymer and further reacting the intermediate copolymer with below-indicated compound (d).

Monomer (a) includes a radically-polymerizable double bond and a polyorganosiloxane chain A.

Monomer (b) is a radically-polymerizable monomer including a radically-polymerizable double bond and a reactive functional group.

Monomer (c) is a monomer that is other than monomer (a) and monomer (b) and has a radically-polymerizable double bond.

Compound (d) includes functional group D that can react with the reactive functional group, and a radically-polymerizable double bond.

A functional group equivalent of the radically-polymerizable double bond in the vinyl copolymer is 35000 g/mol or less. From the perspective of enhancement in a crosslink density of the surface layer, the functional group equivalent of the radically-polymerizable double bond in the vinyl copolymer is preferably 100 to 5000 g/mol, more preferably, 100 to 1000 g/mol, even more preferably, 100 to 500 g/mol. Here, the “functional group equivalent of the radically-polymerizable double bond” means “an equivalent of a functional group (for example, a (meth)acryloyl group) including a radically-polymerizable double bond”.

A molecular weight of the polyorganosiloxane chain A is, for example, within a range of 1,000 to 10,000 in the weight-average molecular weight of monomer (a).

Also, “radically-polymerizable double bond” refers to, for example, a carbon-carbon double bond in a vinyl group.

One or more types of monomers (a) may be included. The number of polyorganosiloxane chains A and the number of radically-polymerizable double bonds included in monomer (a) may be both one or more. Examples of monomer (a) include a polyorganosiloxane compound containing a single-end (meth)acryloxy group. Commercially available examples of monomer (a) include: TSL9705 manufactured by GE Toshiba Silicone Co. Ltd; Silaplane FM-0711, FM-0721 and FM-0725 manufactured by Chisso Corporation; and X-22-174DX, X-22-2426 and X-22-2475 manufactured by Shin-Etsu Chemical Co., Ltd. A copolymerization ratio of monomer (a) in the intermediate copolymer is preferably 1 to 80 wt %, more preferably, 5 to 50 wt %, even more preferably, 10 to 45 wt % relative to a total weight of monomers included in the intermediate copolymer.

One or more types of monomer (b) may be included. The number of radically-polymerizable double bonds and the number of reactive functional groups included in monomer (b) may be both one or more. Examples of the reactive functional group included in monomer (b) include a hydroxyl group, a carboxyl group, an isocyanate group and an epoxy group.

Examples of monomer (b) including a hydroxyl group include 2-hydroxyethyl(meth)acrylate, 1-hydroxypropyl(meth)acrylate, 2-hydroxypropyl(meth)acrylate, 4-hydroxybutyl(meth)acrylate, polyethyleneglycol mono(meth)acrylate, polypropyleneglycol mono(meth)acrylate, polytetramethyleneglycol mono(meth)acrylate, and hydroxystyrene.

Examples of monomer (b) including a carboxyl group(s) include acrylic acid, methacrylic acid, crotonic acid, maleic acid, fumaric acid, itaconic acid and citraconic acid.

Examples of monomer (b) including an isocyanate group(s) include: (meth)acryloyloxyethylisocyanate; (meth)acryloyloxypropylisocyanate; and a reaction product between hydroxyalkyl(meth)acrylate and polyisocyanate. Examples of the hydroxyalkyl(meth)acrylate include 2-hydroxyethyl(meth)acrylate and 4-hydroxybutyl(meth)acrylate. Examples of the polyisocyanate include toluene diisocyanate and isophorone diisocyanate.

Examples of monomer (b) including an epoxy group include glycidyl methacrylate, glycidyl cinnamate, glycidyl allyl ether, glycidyl vinyl ether, vinylcyclohexane monoepoxide and 1,3-butadiene monoepoxide.

A copolymerization ratio of monomer (b) in the intermediate copolymer is preferably 10 to 95 wt %, more preferably 30 to 90 wt %, and particularly preferably 40 to 85 wt % relative to a total weight of monomers included in the intermediate copolymer.

Monomer (c) is a monomer other than monomer (a) and monomer (b). One or more types of monomer (c) may be included. The number of the radically-polymerizable double bonds included in monomer (c) may be one or more. Examples of monomer (c) include (i) (meth)acrylic acid derivative, (ii) aromatic vinyl monomer, (iii) olefinic hydrocarbon monomer, (iv) vinylester monomer, (v) vinylhalide monomer and (vi) vinylether monomer.

Examples of (i) (meth)acrylic acid derivative include: (meth)acrylonitrile; alkyl(meth)acrylate such as methyl(meth)acrylate, butyl(meth)acrylate, ethylhexyl(meth)acrylate and stearyl(meth)acrylate; and benzyl(meth)acrylate.

Examples of (ii) aromatic vinyl monomer include styrenes such as styrene, methylstyrene, ethylstyrene, chlorostyrene, monofluoromethylstyrene, difluoromethylstyrene and trifluoromethylstyrene.

Examples of (iii) olefinic hydrocarbon monomer include ethylene, propylene, butadiene, isobutylene, isoprene and 1,4-pentadiene.

Examples of (iv) vinylester monomer include vinyl acetate.

Examples of (v) vinylhalide monomer include vinyl chloride and vinylidene chloride.

Examples of (vi) vinylether monomer include vinylmethylether.

A copolymerization ratio of monomer (c) in the intermediate copolymer is preferably 0 to 89 wt % relative to the total weight of monomers included in the intermediate copolymer.

Compound (d) includes functional group D that can react with the reactive functional group in monomer (b). One or more types of compound (d) may be included. Also, one or more types of functional group D may be included. The number of radically-polymerizable double bonds and the number of functional groups D included in compound (d) may be both one or more. For example, if the reactive functional group in monomer (b) is a hydroxyl group, examples of functional group D include an acid halide group and an isocyanate group. Examples of compound (d) include (meth)acryloyl chloride and methacryloxyethyl isocyanate.

If the reactive functional group in monomer (b) is a carboxyl group, examples of functional group D include an epoxy group. Examples of compound (d) include glycidyl vinyl ether, vinylcyclohexane monoepoxide and 1,3-butadiene monoepoxide.

If the reactive functional group in monomer (b) is an isocyanate group, examples of functional group D include a hydroxyl group. Examples of compound (d) as described above include hydroxyethyl(meth)acrylate, hydroxypropyl(meth)acrylate, hydroxybutyl(meth)acrylate, ε-caprolactone adduct of hydroxyethyl(meth)acrylate and 2-hydroxyethyl acrylate adduct of isophorone diisocyanate (IPDI).

If the reactive functional group in monomer (b) is an epoxy group, examples of functional group D include a carboxyl group. Examples of compound (d) described above include (meth)acrylic acid, succinic anhydride adduct of pentaerythritol triacrylate, and (meth)acryloxyethyl phthalate.

It is preferable to react compound (d) with the intermediate copolymer at a ratio in which the number of functional groups D is 100% relative to the number of the reactive functional groups included in the intermediate copolymer. It should be understood that the ratio may be smaller than 100% so long as the reactivity of the vinyl copolymer to actinic ray is not impaired.

As another example of the vinyl copolymer, a vinyl copolymer according to Japanese Patent Application Laid-Open No. 2007-77188 may be used.

From the perspective of maintenance of the low surface free energy characteristic of the surface layer, a content of the vinyl copolymer in the curable composition is preferably 5 to 75 parts by volume, more preferably 5 to 50 parts by volume, relative to 100 parts by volume of the curable composition. If the content of the vinyl copolymer is smaller than 5 parts by volume, no sufficiently-low surface free energy characteristic may be provided in the surface layer. If the content of the vinyl copolymer is larger than 75 parts by volume, neither sufficient film strength nor hardness may be provided in the surface layer.

The multifunctional (meth)acrylate include two or more (meth)acryloyloxy groups in one molecule. One or more types of the multifunctional (meth)acrylate may be included. Examples of the multifunctional (meth)acrylate include: bifunctional monomers such as bis(2-acryloxyethyl)-hydroxyethylisocyanurate, 1,6-hexanediol diacrylate, 1,4-butanediol diacrylate, 1,9-nonanediol diacrylate, neopentylglycol diacrylate and hydroxypivalate neopentylglycol diacrylate, urethaneacrylate; multifunctional monomers including three or more functional groups such as trimethylolpropane triacrylate, pentaerythritol triacrylate, tris(acryloxyethyl)isocyanurate, ditrimethylolpropane tetraacrylate, pentaerythritol tetraacrylate, dipentaerythritolhexaacrylate, urethaneacrylate, an ester compound synthesized from a polyalcohol, a polybasic acid and (meth)acrylic acid (for example, an ester compound synthesized from trimethylolethane, succinic acid and acrylic acid in a molar ratio of 2:1:4). The multifunctional (meth)acrylate is preferably a multifunctional acrylate including three or more functional groups from the perspective of enhancement of the hardness of the surface layer.

From the perspective of enhancement of the hardness of the surface layer, a content of the multifunctional (meth)acrylate in the curable composition is preferably 25 to 95 parts by volume, more preferably 50 to 95 parts by volume, relative to 100 parts by volume of the curable composition.

The curable composition may further contain other components as long as advantageous effects of the present invention can be provided. Examples of such other components include an organic solvents and a photopolymerization initiator.

The organic solvent can be used from the perspective of, for example, dissolution and/or even dispersion of a solute and/or enhancement in coating characteristics for surface layer formation. The organic solvent may be used solely or in combination with another organic solvent. Examples of the organic solvent include alcohols, hydrocarbons, halogenated hydrocarbons, ethers, ketones, esters and polyalcohol derivatives.

The photopolymerization initiator may be of one or more types. Examples of the photopolymerization initiator include carbonyl compounds such as benzoin, benzoin methyl ether, benzoin ethyl ether, benzoin isopropyl ether, benzoin isobutyl ether, acetoin, butyroin, toluoin, benzil, benzophenone, p-methoxybenzophenone, diethoxyacetophenone, 2,2-dimethoxy-2-phenylacetophenone, methyl phenylglyoxylate, ethyl phenylglyoxylate, 4,4-bis(dimethylaminobenzophenone), 2-hydroxy-2-methyl-1-phenylpropan-1-one, 1-hydroxycyclohexyl phenyl ketone and 1-(4-isopropylphenyl)-2-hydroxy-2-methylpropane-1-one; sulfur compounds such as tetramethylthiuram disulfide and tetramethylthiuram disulfide; azo compounds such as azobisisobutyronitrile and azobis-2,4-dimethyl valeronitrile; peroxide compounds such as benzoyl peroxide, di tert-butyl peroxide; and phosphineoxide compounds such as 2,4,6-trimethylbenzoyldiphenylphosphineoxide. A content of the photopolymerization initiator is, for example, 0.1 to 20 wt %, preferably 1 to 10 wt % relative to the total weight of the curable composition.

The metal oxide fine particles in the surface layer prevent abrasion of the surface layer and reinforce the surface layer. The particle shape of the metal oxide fine particles is not specifically limited. The size of the metal oxide fine particles is preferably 1 to 100 nm by average particle size. The average particle size may be, for example, a number average particle size or a catalog value. Examples of core particles for forming the metal oxide fine particles include alumina particles, tin oxide particles and titania particles, more preferably, alumina particles or tin oxide particles, even more preferably alumina particles.

The metal oxide fine particles are obtained by surface-treating the core particles with a surface treating agent. The surface treating agent contains at least a compound including a polyorganosiloxane chain B. The polyorganosiloxane chain B may have a structure that is the same as that of the polyorganosiloxane chain A included in the vinyl copolymer or may have a structure that is different from that of the polyorganosiloxane chain A. Also, the number of polyorganosiloxane chains B in the compound including a polyorganosiloxane chain B may be one or more.

Examples of the compound including a polyorganosiloxane chain B include methylhydrogenpolysiloxane and modified silicone oil. From the perspective of provision of desired characteristics by means of the surface treatment of the core particles and easiness of handling in surface treatment, a molecular weight of each of such compounds is, for example, 300 to 20,000. The modified silicone oil is obtained by introducing an organic group to a polyorganosiloxane chain. The organic group may be located at any of a side chain, a single end or both ends of the polyorganosiloxane chain. Examples of the modified silicone oil include amino modified silicone, epoxy modified silicone, carbinol modified silicone, mercapto modified silicone and carboxyl modified silicone. The compound including a polyorganosiloxane chain B is more preferably methylhydrogenpolysiloxane or carbinol modified silicone.

The metal oxide fine particles are obtained by, for example, dispersing the core particles in the surface treating agent itself or a mixed solution of the surface treating agent and an organic solvent, and collecting and drying the core particles. A quantity of the surface treating agent in the surface of the metal oxide fine particles can be adjusted by a concentration of the surface treating agent during dispersion of the core particles and/or the number of repetitions of dispersion steps.

A content of the metal oxide fine particles in the surface coating material is preferably 10 to 100 parts by volume per 100 parts by volume of the curable composition. If the content of the metal oxide fine particles is too small, the hardness of the resulting surface layer is small, and if the content of the metal oxide fine particles is too large, the resulting surface layer becomes brittle. If the content of the metal oxide fine particles in the surface coating material is too large, a dispersed state of the metal oxide fine particles cannot be maintained, resulting in sedimentation of the metal oxide fine particles, and thus, the content is more preferably 10 to 70 parts by volume, even more preferably 10 to 50 parts by volume, relative to 100 parts by volume of the curable composition.

In the surface coating material, it is preferable that the curable composition contains the vinyl copolymer and the multifunctional (meth)acrylate and the content of the metal oxide fine particles is 10 to 100 parts by volume per 100 parts by volume of the curable composition. As described above, the content of the vinyl copolymer in the curable composition is preferably 5 to 75 parts by volume, more preferably 5 to 50 parts by volume, relative to 100 parts by volume of the curable composition. Also, as described above, the content of the multifunctional (meth)acrylate in the curable composition is preferably 25 to 95 parts by volume, more preferably 50 to 95 parts by volume, relative to 100 parts by volume of the curable composition from the perspective of enhancement of the hardness of the surface layer.

The surface coating material may further contain another component, for example, an organic solvent such as mentioned above so long as the advantageous effects of the present invention can be provided.

The surface coating material is obtained by dispersing the metal oxide fine particles in the curable composition. Such dispersion can be performed using a conventional dispersion apparatus. The dispersion apparatus preferably provides a smallest possible shear in dispersion from the perspective of preventing the peeling of a film resulting from the surface treatment of the metal oxide fine particle surface which peeling is induced by shear in dispersion. For such dispersion apparatus, an ultrasonic homogenizer can be used. An ultrasonic homogenizer is an apparatus that generates cavitation by ultrasonic waves to vibrate agglomerated particles, thereby disintegrating agglomerated particles into fine particles. Furthermore, examples of the dispersion apparatus include bead mills such as a Dispermat. In this case, use of beads with smaller grain diameters or dispersion with a low rotation frequency (for example, 500 to 1,000 rpm) is preferable.

The surface of the metal oxide fine particles have been treated by the surface treating agent including a polyorganosiloxane chain B. Accordingly, the metal oxide fine particles are evenly dispersed in the surface coating material film. Meanwhile, the polyorganosiloxane chain A included in the vinyl copolymer in the curable composition has an affinity to the polyorganosiloxane chain B. Thus, the vinyl copolymers containing the polyorganosiloxane chain A collect in the peripheries of the metal oxide fine particles evenly dispersed in the surface coating material film. As a result, the vinyl copolymer is evenly dispersed in the surface coating material film. Accordingly, the surface layer of the intermediate transfer member exhibits desired low surface free energy and desired durability irrespective of whether or not the surface layer has been abraded.

2. Image Forming Apparatus

An image forming apparatus according to the present invention can be configured in a manner that is similar to those of conventional electrophotographic image forming apparatuses using an intermediate transfer member except the image forming apparatus according to the present invention includes the intermediate transfer member according to the present invention as described above. Examples of such conventional image forming apparatuses include an image forming apparatus including a plurality of developing devices and an intermediate transfer member onto which respective toner images formed by the respective developing devices are transferred so as to overlap one another.

An embodiment of the present invention will further be described with reference to the accompanying drawings.

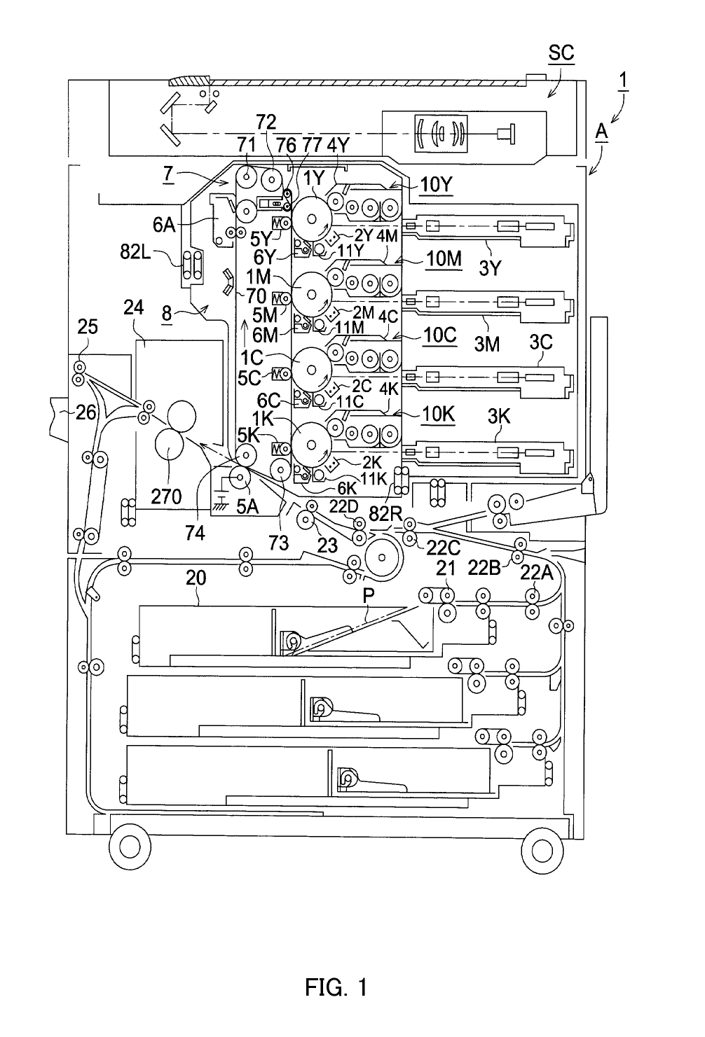

Full-color image forming apparatus 1 illustrated in FIG. 1 includes casing 8 that can be drawn out from apparatus body A via support rails 82L and 82R, a set of image forming units 10Y, 10M, 10C and 10K, intermediate transfer unit 7, which serves as a transfer section, endless belt type sheet feeding section 21 that feeds recording medium P, and belt-type fixing unit 24, which serves as a fixing section. At an upper portion of body A of full-color image forming apparatus 1, image reading device SC is arranged.

Casing 8 includes image forming units 10Y, 10M, 10C, and 10K and intermediate transfer unit 7. Upon casing 8 being drawn out, image forming units 10Y, 10M, 10C and 10K and intermediate transfer unit 7 are integrally drawn out from body A.

Image forming units 10Y, 10M, 10C and 10K are vertically arranged in a row. Image forming units 10Y, 10M, 10C and 10K have the same structure except that colors of toners contained in respective image forming units are different from one another. Y represents yellow, M represents magenta, C represents cyan and K represents black. For example, image forming unit 10Y includes drum-type photoconductor 1Y, and charging section 2Y, light exposure section 3Y, developing section 4Y and cleaning section 6Y which are all arranged around photoconductor 1Y, and also includes fatty acid metal salt member 11Y in photoconductor 1Y. The fatty acid metal salt is, for example, the same as a fatty acid metal salt included in the toner.

Intermediate transfer unit 7 is arranged on the left side of photoconductors 1Y, 1M, 1C and 1K in the FIG. 1 sheet. Intermediate transfer unit 7 includes endless intermediate transfer belt 70 rotatably looped around rollers 71, 72, 73, 74, 76 and 77, primary transfer rollers 5Y, 5M, 5C and 5K for transferring toner images carried on respective photoconductors 1Y, 1M, 1C and 1K onto intermediate transfer belt 70, and cleaning section 6A. Intermediate transfer belt 70 corresponds to an intermediate transfer member according to the present invention. A cleaning member of cleaning section 6A is an elastic blade.

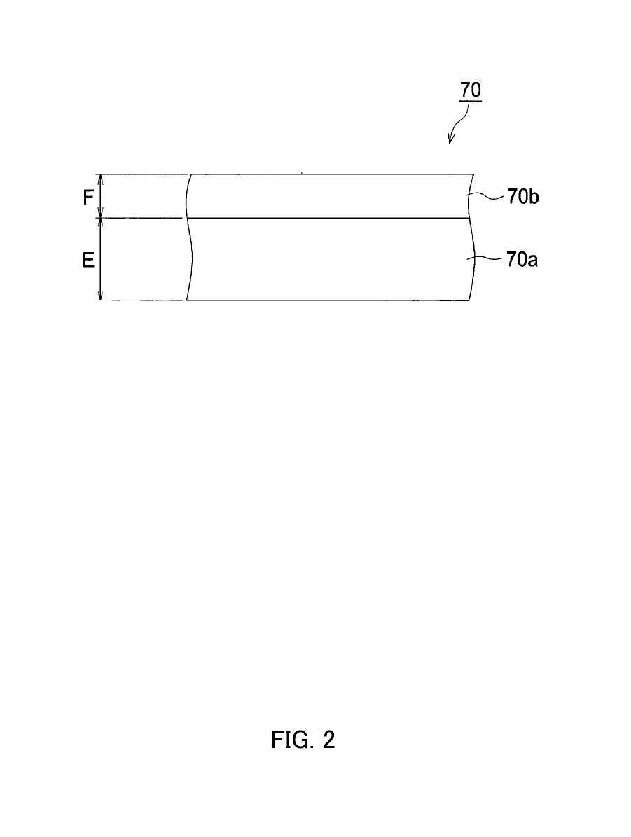

As illustrated in FIG. 2, intermediate transfer belt 70 includes surface layer 70b provided on substrate 70a. A configuration of surface layer 70b is not specifically limited and thus, surface layer 70b may include one layer or two layers. In FIG. 2, surface layer 70b is configured in one layer.

Thickness E of substrate 70a is preferably 50 to 250 μm in consideration of, e.g., mechanical strength, image quality and manufacturing costs.

Thickness F of surface layer 70b is preferably 0.5 to 5 μm in consideration of toner transfer ratio, durability, filming and image quality. The thickness of the surface layer can be measured using a Fischerscope® MMS manufactured by Fischer Instruments.

In full-color image forming apparatus 1, first, toner images of respective colors are formed by respective image forming units 10Y, 10M, 10C and 10K. Outer peripheral surfaces of photoconductors 1Y, 1M, 1C and 1K are charged and exposed to light, whereby latent images are formed on the respective outer peripheral surfaces. Subsequently, toner images (visible images) are formed on the outer peripheral surfaces by means of development.

The toner images of the respective colors formed by image forming units 10Y, 10M, 10C and 10K are sequentially transferred onto rotating intermediate transfer belt 70 by primary transfer rollers 5Y, 5M, 5C and 5K. Consequently, a color toner image resulting from superimposition of the toner images of the respective colors is formed on intermediate transfer belt 70.

The color toner image on intermediate transfer belt 70 is transferred onto recording medium (toner receiving article) P. Recording medium P such as a sheet loaded in sheet feeding cassette 20 is fed by sheet feeding section 21 and conveyed to secondary transfer roller 5A via a plurality of intermediate rollers 22A, 22B, 22C and 22D and registration roller 23. Then, the color toner image on intermediate transfer belt 70 is transferred onto recording medium P by secondary transfer roller 5A.

The color toner image transferred on recording medium P is fixed to recording medium P by pressure and heat applied using belt-type fixing unit 24 equipped with heat roller fixing device 270. Recording medium P with the color toner image fixed thereto is sandwiched by sheet discharging rollers 25 and outputted on external sheet tray 26.

Toners remaining on respective photoconductors 1Y, 1M, 1C and 1K after the transfer of the toner image of the respective colors onto intermediate transfer belt 70 are removed by respective cleaning sections 6Y, 6M, 6C and 6K. Subsequently, photoconductors 1Y, 1M, 1C and 1K each enter the above cycle of charging, exposure and development for next image formation. Toner remaining on intermediate transfer belt 70 is removed by cleaning section 6A.

In the intermediate transfer member according to the present embodiment, metal oxide fine particles and silicone components in resin components are evenly distributed in the surface layer of the intermediate transfer member. Accordingly, the intermediate transfer member enables suppression of filming even in long-term use and also enables maintenance of low surface energy.

Next, manufacture of the intermediate transfer member according to the present embodiment will be described.

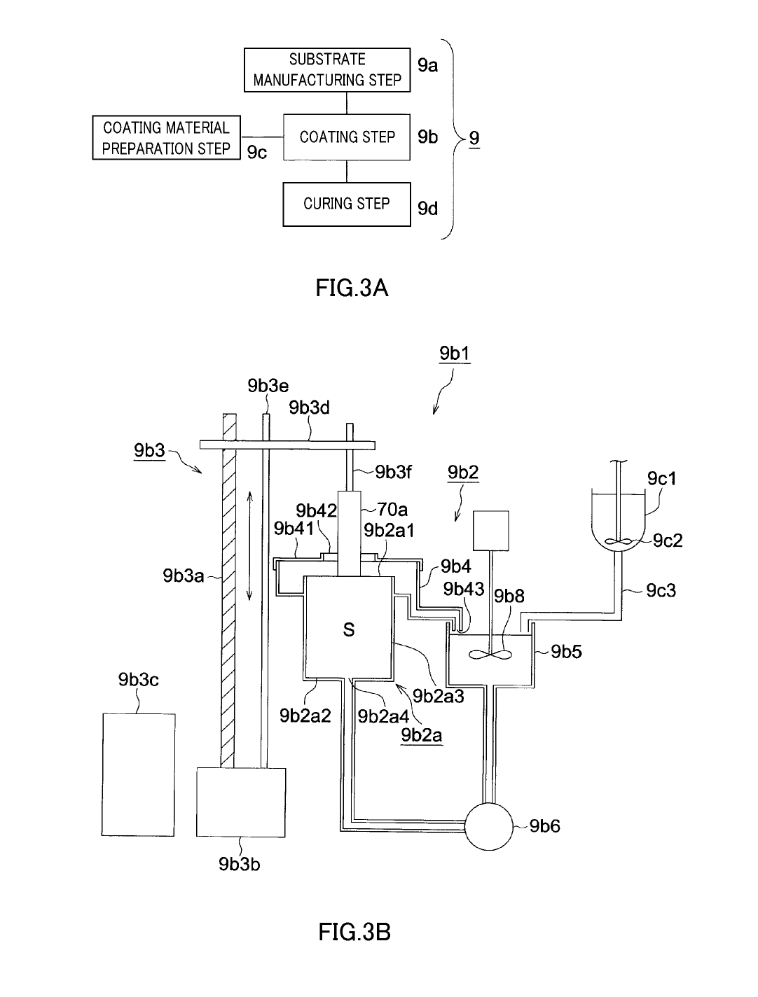

FIG. 3A is a diagram of a schematic flow of manufacturing the intermediate transfer belt illustrated in FIG. 2. FIG. 3B is a schematic diagram illustrating an example of a dip coating apparatus that applies a surface coating material to a surface of a substrate used in the coating step illustrated in FIG. 3A.

Manufacturing process 9 for intermediate transfer belt 70 includes substrate manufacturing step 9a of manufacturing an endless belt type substrate, coating material preparation step 9c of preparing a surface coating material, coating step 9b of applying a surface coating material to a surface of the manufactured substrate, and curing step 9d of curing the surface coating material film formed in the coating step.

In substrate manufacturing step 9a, substrate 70a illustrated in FIG. 2 is manufactured by a conventionally known common manufacturing method. For example, a resin as a material is melted through an extruder and formed into a cylindrical shape by the inflation technique using an annular die, and the resulting cylindrical product is cut into round slices, whereby an annular endless belt type substrate can be manufactured.

The cylindrical product can also be obtained by, for example, drying a ring-like coating film of a polyamide acid so as to have a belt-like shape and heating the resulting formed product to imidize the polyamide acid and collecting the resulting product (see, for example, Japanese Patent Application Laid-Open Nos. 61-95361, 64-22514 and 3-180309). Examples of methods for forming a ring-like coating film of a polyamide acid include the following methods where: a polyamide acid solution is applied to the outer peripheral surface of a cylindrical mold; the solution is applied to the inner peripheral surface of a cylindrical mold; the solution is applied to the inner peripheral surface of a cylindrical mold and the resulting coating film is centrifuged; and the solution is charged into a casting mold.

For manufacture of an endless belt, any proper treatments such as mold releasing and defoaming may be performed. Substrate 70a preferably has conductivity. The conductivity of substrate 70a can be provided or adjusted by dispersing a conductive agent in the resin.

Coating material preparation step 9c can be performed using coating material preparation container 9c1, stirrer 9c2, and liquid feed pipe 9c3 that feeds a prepared surface coating material to coating material supply tank 9b5 in dip coating apparatus 9b1. The surface coating material prepared in coating material preparation step 9c contains the curable composition and the metal oxide fine particles described above. The metal oxide fine particles have been surface-treated with the above-described surface treating agent including a polyorganosiloxane chain.

Coating step 9b can be performed using dip coating apparatus 9b1. Dip coating apparatus 9b1 includes coating section 9b2 and supply section 9b3 that supplies a substrate for an intermediate transfer belt. Coating section 9b2 includes coating bath 9b2a, overflown solution receiving bath 9b4 disposed at an upper portion of coating bath 9b2a, overflown solution receiving bath 9b4 receiving a surface coating material overflown from opening portion 9b2a1 of coating bath 9b2a, coating material supply tank 9b5, and liquid feed pump 9b6. S denotes a surface coating material.

Coating bath 9b2a includes bottom portion 9b2a2 and side wall 9b2a3 erected from a periphery of bottom portion 9b2a2, and the upper portion of coating bath 9b2a includes opening portion 9b2a1. Coating bath 9b2a has a cylindrical shape. Opening portion 9b2a1 and bottom portion 9b2a2 have the same diameter. 9b2a4 denotes a coating material supply port provided at bottom portion 9b2a2 of coating bath 9b2a. Surface coating material S is fed from liquid feed pump 9b6 to coating bath 9b2a via coating material supply port 9b2a4.

9b41 denotes a lid of overflown solution receiving bath 9b4. Lid 9b41 includes hole 9b42 at a center thereof. 9b43 denotes coating material return port that returns surface coating material S in overflown solution receiving bath 9b4 to coating material supply tank 9b5. 9b8 denotes a stirring fin provided in coating material supply tank 9b5.

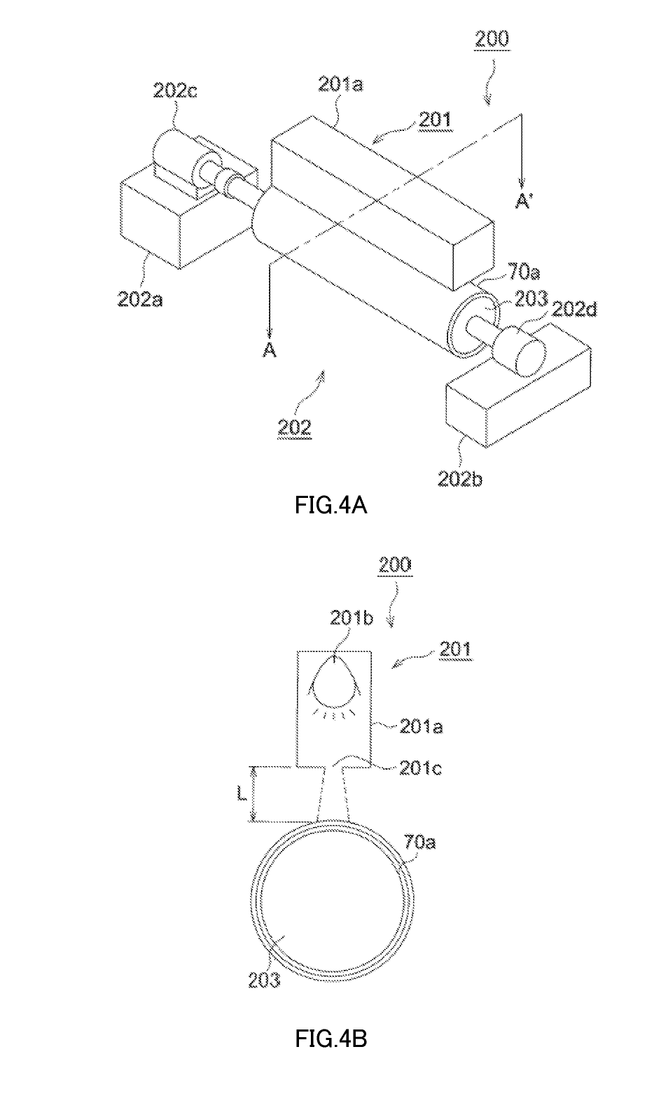

Supply section 9b3 includes ball screw 9b3a, drive section 9b3b that rotates ball screw 9b3a, control section 9b3c that controls a rotation speed of ball screw 9b3a, lifting member 9b3d threadably connected to ball screw 9b3a, and guide member 9b3e that moves lifting member 9b3d in vertical directions (directions indicated by the double-headed arrow in the Figure) along with rotation of ball screw 9b3a. 9b3f denotes a holding member that holds substrate 70a, the holding member being attached to lifting member 9b3d. Here, substrate 70a is held on a surface of cylindrical member 203 (see FIGS. 4A and 4B) adjusted to a diameter of substrate 70a. Holding member 9b3f is attached to lifting member 9b3d in such a manner that held substrate 70a is positioned at a substantial center of coating bath 9b2a.

Substrate 70a is held by holding member 9b3f attached to lifting member 9b3d. Along with rotation of ball screw 9b3a, lifting member 9b3d moves vertically. Consequently, substrate 70a held by holding member 9b3f is dipped in surface coating material S in coating bath 9b2a and then is lifted up. Consequently, surface coating material S is applied to a surface of substrate 70a, whereby a surface coating material film is formed.

It is necessary to suitably change a speed for lifting up substrate 70a as appropriate according to the viscosity of surface coating material S to be used. For example, if the viscosity of surface coating material S is 10 to 200 mPa·s, the speed for lifting substrate 70a up is preferably 0.5 to 15 mm/sec in consideration of, e.g., coating evenness, surface coating material film thickness and drying.

In order to efficiently advance a curing reaction by an actinic ray, the surface coating material film may be heated and dried before curing of the surface coating material film. The heating method is not specifically limited, but examples of the heating method include hot-air blowing. The heating temperature cannot uniquely be determined because of the variety of curable compositions to be used, but preferably, falls within a range of temperatures that do not affect the surface coating material film, and thus, preferably 40 to 100° C., more preferably 40 to 80° C., particularly preferably 40 to 60° C.

For application of surface coating material S to the surface of substrate 70a in the present invention, any of other known methods can be employed. Examples of the other methods include annular coating methods using an annular coating bath, spray coating methods and coating method using an ultrasonic atomizer.

Curing step 9d can be performed using curing apparatus 200 illustrated in FIGS. 4A and 4B.

FIGS. 4A and 4B are schematic diagrams illustrating an example of a curing apparatus for a surface layer, which is used in the curing step illustrated in FIGS. 3A and 3B. FIG. 4A is a perspective diagram schematically illustrating an example of a curing apparatus for a surface layer (protection layer), which is used in the curing step illustrated in FIG. 3A. FIG. 4B is a diagram illustrating a cross-section of the curing apparatus along line A-A′ of FIG. 4A.

Curing apparatus 200 includes actinic ray irradiation apparatus (hereinafter also referred to as “irradiation apparatus”) 201, cylindrical member 203 that holds substrate 70a with a surface coating material film on a surface thereof, and holding device 202 that rotatably holds cylindrical member 203. Cylindrical member 203 may be a round bar member.

Irradiation apparatus 201 is fixed to a frame (not illustrated) of curing apparatus 200. Irradiation apparatus 201 is disposed at a position facing cylindrical member 203 so as to irradiate cylindrical member 203 with an actinic ray. Irradiation apparatus 201 includes casing 201a, actinic ray source (hereinafter also referred to as “irradiation source”) 201b housed in casing 201a, and energy control device (not illustrated) for irradiation source 201b.

201c denotes a port for actinic ray irradiation, which is provided at a bottom portion of casing 201a (face facing the surface of substrate 70a). L denotes a distance from irradiation port 201c to the surface of substrate 70a. Distance L can arbitrarily be set according to, e.g., the intensity of the actinic ray and/or the type of curing components in the surface coating material film.

Holding device 202 includes first holding table 202a and second holding table 202b, drive motor 202c, and bearing portion 202d. Motor 202c is disposed on first holding table 202a, and bearing portion 202d is disposed on second holding table 202b.

Cylindrical member 203 is connected to a rotating shaft of motor 202c via one attachment shaft of cylindrical member 203 and a connection member. Also, cylindrical member 203 is connected to bearing portion 202d via another attachment shaft of cylindrical member 203. Consequently, cylindrical member 203 is held in such a manner that, driven by motor 202c, cylindrical member 203 can rotate.

Upon driving of motor 202c, cylindrical member 203 rotates. Then, cylindrical member 203 is radiated with an actinic ray with irradiation apparatus 201. Consequently, the surface coating material film on the surface of substrate 70a cures, whereby surface layer 70b is formed.

The rotation speed (circumferential velocity) of cylindrical member 203 when cylindrical member 203 is irradiated with an actinic ray is preferably 10 to 300 mm/s in consideration of, e.g., curing unevenness, hardness and/or curing time.

For an actinic ray that can be used for the present invention, any actinic ray that activates a formed curable composition, such as ultraviolet ray, electron ray or γ-ray, without limitation thereto, can be used; however, ultraviolet ray or electron ray is preferable. In particular, ultraviolet ray is preferable because ultraviolet ray is easy to handle and enables high energy to be obtained easily. For a light source for ultraviolet ray, any light source that generates ultraviolet ray can be used. For example, a low-pressure mercury lamp, a medium-pressure mercury lamp, a high-pressure mercury lamp, an ultrahigh-pressure mercury lamp, a carbon-arc lamp, a metal halide lamp, a xenon lamp may be used. Also, e.g., an ArF excimer laser, a KrF excimer laser, an excimer lamp or a synchrotron radiation may be used. In order to irradiate with a spot actinic ray, it is preferable to use an ultraviolet laser.

An electron ray can also be used. For an electron ray, an electron ray having energy of 50 to 1000 keV, preferably 100 to 300 keV, which is emitted from an electron ray accelerators of any of various types such as the Cockcroft-Walton type, the Van de Graaf type, the resonance transformation type, the insulated core transformer type, the linear type, the Dynamitron type and the radio-frequency type can be employed.

Although irradiation conditions differ depending on the respective light sources, an irradiating light quantity is preferably 100 m J/cm² or more, more preferably 120 to 200 mJ/cm², particularly preferably 150 to 180 mJ/cm² in consideration of, e.g., curing unevenness, hardness, curing time and/or curing speed. The irradiating light quantity is a value measured by UIT250 (manufactured by Ushio Inc.).

For actinic ray irradiation time, 0.5 seconds to 5 minutes is preferable, and from the perspective of, e.g., curable composition curing efficiency and/or work efficiency, 3 seconds to 2 minutes is more preferable.

For an atmosphere during actinic ray irradiation, curing is possible with no problem in an air atmosphere; however, an oxygen concentration in the atmosphere is preferably 5% or less, particularly preferably 1% or less in consideration of, e.g., curing unevenness and/or curing time. In order to provide such atmosphere, it is effective to introduce, e.g., nitrogen gas. The oxygen concentration can be measured by an OX100 oxygen analyzer for monitoring ambient gases (manufactured by Yokogawa Electric Corporation).

In the mode illustrated in FIGS. 4A and 4B, cylindrical member 203 is irradiated with an actinic ray while cylindrical member 203 is rotated with fixed irradiation apparatus 201; however, it is possible that cylindrical member 203 is fixed and irradiation apparatus 201 moves along a periphery of cylindrical member 203. Also, in the mode illustrated in FIGS. 4A and 4B, cylindrical member 203 is horizontally arranged; however, it should be understood that cylindrical member 203 may be vertically arranged.

### EXAMPLES

### 1. Synthesis of Radical Reactive Siloxane Graft Polymer

(Synthesis of IPDI Adduct)

222 parts by weight of isophoronediisocyanate (IPDI) was heated to 80° C. in a 1 L four-necked flask in the air and then 116 parts by weight of 2-hydroxyethylacrylate and 0.13 parts by weight of hydroquinone was added dropwise thereinto over two hours, and then the resultant was allowed to react at 80° C. for three hours, whereby a compound including one isocyanate group and one vinyl group (IPDI adduct) was obtained.

(Synthesis of Polymer A-1)

15 parts by weight of a single-end methacryloxy group-containing polysiloxane compound (“Silaplane FM-0721” manufactured by Chisso Corporation), 70 parts by weight of 2-hydroxyethyl methacrylate, 15 parts by weight of butyl methacrylate and 200 parts by weight of methyl isobutyl ketone (MIBK) were put into a four-necked flask equipped with a condenser, a stirring device and a thermometer and heated to 80° C. while being stirred in a nitrogen stream, followed by addition of 3 parts by weight of azobisisobutyronitrile to cause polymerization reaction for two hours, and further followed by addition of 1 part by weight of azobisisobutyronitrile, causing polymerization for two hours. Next, a solution obtained by dissolving 204 parts by weight of IPDI adduct and 1 part by weight of tin octylate in 20 parts by weight of methyl ethyl ketone (MEK) was added dropwise into the resultant over approximately 10 minutes, causing a reaction for two hours after the addition. And then, cyclohexanone was added to the resulting solution so that the concentration of a non-volatile component therein was adjusted to 10 wt %, whereby a solution of polymer A-1 was obtained. The weight-average molecular weight of polymer A-1 was approximately 20,000, and the functional group equivalent of methacryloyl groups was 185 g/mol.

(Synthesis of Polymer A-2)

20 parts by weight of a single-end methacryloxy group-containing polysiloxane compound (“Silaplane FM-0721” manufactured by Chisso Corporation), 70 parts by weight of glycidyl methacrylate, 10 parts by weight of butyl methacrylate and 200 parts by weight of methyl isobutyl ketone (MIBK) were put into a four-necked flask equipped with a condenser, a stirring device and a thermometer and heated to 90° C. while being stirred in a nitrogen stream, followed by addition of 3 parts by weight of azobisisobutyronitrile to cause a polymerization reaction for two hours, and further addition of 1 part by weight of azobisisobutyronitrile to cause polymerization for two hours. Next, the resultant was heated to 100° C. and the inflow gas was changed from nitrogen to air, followed by addition of 0.7 parts by weight of dimethylbenzylamine, and subsequently, 35 parts by weight of acrylic acid was added dropwise into the resultant over approximately 10 minutes, and after the addition, the resultant was allowed to react for 10 hours. And then, cyclohexanone was added to the resulting solution so that the concentration of a non-volatile component therein was adjusted to 10 wt %, whereby a solution of polymer A-2 was obtained. The weight-average molecular weight of polymer A-2 was approximately 17,000, and the functional group equivalent of methacryloyl groups was 200 g/mol.

(Synthesis of Polymer A-3)

25 parts by weight of a single-end methacryloxy group-containing polysiloxane compound (“Silaplane FM-0721” manufactured by Chisso Corporation), 30 parts by weight of methacryloyloxyethylisocyanate, 45 parts by weight of butylmethacrylate and 200 parts by weight of methyl ethyl ketone (MEK) were put into a four-necked flask equipped with a condenser, a stirring device and a thermometer and heated to 80° C. while being stirred in a nitrogen stream, followed by addition of 1.6 parts by weight of azobisisobutyronitrile to cause a polymerization reaction for two hours and further followed by addition of 0.4 parts by weight of azobisisobutyronitrile to cause polymerization for two hours. Next, a solution obtained by dissolving 25.2 parts by weight of 2-hydroxyethyl methacrylate and 0.6 parts by weight of tin octylate in 20 parts by weight of methyl ethyl ketone (MEK) was added dropwise into the resultant over approximately 10 minutes, and after the addition, the resultant was allowed to react for two hours. And then, cyclohexanone was added to the resulting solution so that the concentration of a non-volatile component therein was adjusted to 20 wt %, whereby a solution of polymer A-3 was obtained. The weight-average molecular weight of polymer A-3 was approximately 24,000, and the functional group equivalent of methacryloyl groups was 500 g/mol.

(Synthesis of Polymer A-4)

20 parts by weight of a single-end methacryloxy group-containing polysiloxane compound (“Silaplane FM-0711” manufactured by Chisso Corporation), 70 parts by weight of glycidyl methacrylate, 10 parts by weight of butyl methacrylate and 200 parts by weight of methyl isobutyl ketone (MIBK) were put into a four-necked flask equipped with a condenser, a stirring device and a thermometer and heated to 90° C. while being stirred in a nitrogen stream, followed by addition of 3 parts by weight of azobisisobutyronitrile to cause a polymerization reaction for two hours, and further followed by addition of 1 part by weight of azobisisobutyronitrile to cause polymerization for two hours. Next, the resultant was heated to 100° C., and the inflow gas was changed from nitrogen to air, followed by addition of 0.7 parts by weight of dimethylbenzylamine, and subsequently, 35 parts by weight of acrylic acid was added dropwise into the resultant over approximately 10 minutes, and after the addition, the resultant was allowed to react for 10 hours. And then, cyclohexanone was added to the resulting solution so that the concentration of a non-volatile component therein was adjusted to 10 wt %, whereby a solution of polymer A-4 was obtained. The weight-average molecular weight of polymer A-4 was approximately 15,000 and a functional group equivalent of methacryloyl groups was 200 g/mol.

(Synthesis of Polymer A-5)

20 parts by weight of a single-end methacryloxy group-containing polysiloxane compound (“Silaplane FM-0725” manufactured by Chisso Corporation), 70 parts by weight of glycidyl methacrylate, 10 parts by weight of butyl methacrylate and 200 parts by weight of methyl isobutyl ketone (MIBK) were put into a four-necked flask equipped with a condenser, a stirring device and a thermometer, and heated to 90° C. while being stirred in a nitrogen stream, followed by addition of 3 parts by weight of azobisisobutyronitrile to cause a polymerization reaction for two hours, and further followed by addition of 1 part by weight of azobisisobutyronitrile to cause a polymerization for two hours. Next, the resultant was heated to 100° C., the inflow gas was changed from nitrogen to the air, followed by addition of 0.7 parts by weight of dimethylbenzylamine, and subsequently, 35 parts by weight of acrylic acid was added dropwise into the resultant over approximately 10 minutes, and after the addition, the resultant was allowed to react for 10 hours. And then, cyclohexanone was added to the resulting solution so that the concentration of a non-volatile component therein was adjusted to 10 wt %, whereby a solution of polymer A-5 was obtained. The weight-average molecular weight of polymer A-5 was approximately 30,000 and a functional group equivalent of methacryloyl groups was 200 g/mol.

(Preparation of Polymer A-6)

A single-end methacryloxy group-containing polysiloxane compound (“Silaplane FM-0721” manufactured by Chisso Corporation) was dissolved in cyclohexanone to obtain a solution of polymer (polysiloxane compound) A-6 with a concentration of 20 wt %. The weight-average molecular weight of polymer A-6 was approximately 5,000 and a functional group equivalent of methacryloyl groups was 5000 g/mol.

Raw materials for polymers A-1 to A-6 are indicated in Table 1 below.

TABLE 1

| | Monomer | | | | Functional group |
|---|---|---|---|---|---|
| | (a) | Monomer (b) | Monomer (c) | Compound (d) | equivalent (g/mol) |
| A-1 | FM-0721 | 2-hydroxyethyl methacrylate | Butyl | IPDI adduct | 185 |
| | | | methacrylate | | |
| A-2 | FM-0721 | Glycidyl methacrylate | Butyl | Acrylic acid | 200 |
| | | | methacrylate | | |
| A-3 | FM-0721 | Methacryloyloxyethyl | Butyl | 2-hydroxyethyl | 500 |
| | | isocyanate | methacrylate | methacrylate | |
| A-4 | FM-0711 | Glycidyl methacrylate | Butyl | Acrylic acid | 200 |
| | | | methacrylate | | |
| A-5 | FM-0725 | Glycidyl methacrylate | Butyl | Acrylic acid | 200 |
| | | | methacrylate | | |
| A-6 | FM-0721 | — | — | — | 5000 |

### 2. Preparation of Surface Treated Metal Oxide Fine Particles

(Preparation of Fine Particles P-1)

15 parts by volume of methylhydrogenpolysiloxane (copolymer type), which is a surface treating agent, and 400 parts by volume of a solvent (mixed solvent containing toluene and isopropylalcohol at a volume ratio of 1:1) were mixed into 100 parts by volume of alumina fine particles with an average particle size of 34 nm, which is a filler, and dispersed using a wet-type medium-dispersing apparatus, and then, the solvent was removed, and the resultant was dried at 150° C. for 30 minutes, whereby fine particles P-1 of alumina surface-treated with methylhydrogenpolysiloxane were obtained.

(Preparation of Fine Particles P-2 to P-12)

A procedure similar to that of preparation of fine particles P-1 was taken except that the filler and the surface treating agent were changed as indicated in Table 2 below, whereby fine particles P-2 to P-12 were obtained, respectively. Raw materials for fine particles P-1 to P-12 are indicated in Table 2 below.

TABLE 2

| | Filler | Surface treating agent |
|---|---|---|
| P-1 | Alumina | Methylhydrogenpolysiloxane (copolymer type) |
| P-2 | Alumina | Methylhydrogenpolysiloxane (homopolymer type) |
| P-3 | Alumina | Single end-epoxy modified silicone oil |
| P-4 | Alumina | Single end-carbinol modified silicone oil |
| P-5 | Alumina | Both end-silanol modified silicone oil |
| P-6 | Alumina | Single end-diol modified silicone oil |
| P-7 | Tin oxide | Methylhydrogenpolysiloxane (copolymer type) |
| P-8 | Tin oxide | Methylhydrogenpolysiloxane (homopolymer type) |
| P-9 | Titania | Methylhydrogenpolysiloxane (copolymer type) |
| P-10 | Titania | Methylhydrogenpolysiloxane (homopolymer type) |
| P-11 | Alumina | Methyltrimethoxysilane |
| P-12 | Alumina | 3-acryloxypropyltrimethoxysilane |

Here “methylhydrogenpolysiloxane (copolymer type)” in Table 2 refers to methylhydrogenpolysiloxane including a silicone chain that contains monomer unit A including a silicon atom and two substituents bonded thereto, the substituents including a methyl group and a hydrogen atom, and monomer unit B including a silicon atom and two methyl groups bonded thereto. Examples of this type of methylhydrogenpolysiloxane include KF-9901 manufactured by Shin-Etsu Chemical Co., Ltd.

Also, “methylhydrogenpolysiloxane (homopolymer type)” in Table 2 refers to methylhydrogenpolysiloxane including a silicone chain that includes only monomer unit A above. Examples of this type of methylhydrogenpolysiloxane include KF-99 manufactured by Shin-Etsu Chemical Co., Ltd.

### 3. Preparation of Surface Coating Material

(Preparation of Surface Coating Material 1)

25 parts by volume of polymer A-1 (as solids), 20 parts by volume of fine particles P-1 and 75 parts by volume of dipentaerythritol hexaacrylate (DPHA or also referred to as “M-1”) were mixed and dissolved in 800 parts by volume of methyl isopropyl ketone, and the resultant was put into a horizontal circulation disperser (Dispermat manufactured by EKO Instruments) and φ0.3 mm zirconia beads were put into the disperser so as to provide a filling rate of 80 volume %, and the resultant was dispersed at 1,000 rpm.

Subsequently, the resultant was diluted with methyl isopropyl ketone so that a solid concentration thereof was adjusted to 5 wt %, and 0.25 parts by weight of a photopolymerization initiator (Irgacure 379 manufactured by Ciba Geigy) was mixed in 100 parts by weight of the diluted solution, whereby surface coating material 1 was prepared.

(Preparation of Surface Coating Materials 2 to 20)

A procedure similar to that of preparation of surface coating material 1 was taken except that the polymer, the fine particles and the monomer were changed as indicated in Table 3 below, respectively, whereby respective surface coating materials 2 to 20 were obtained. In Table 3, “M-2” refers to “pentaerythritoltetraacrylate (PTA)”.

### Example 1

### Manufacture of Intermediate Transfer Belt

Surface coating material 1 was applied to a surface of a prepared endless belt type substrate (PI belt) under the following coating conditions using the dip coating apparatus illustrated in FIGS. 3A and 3B by a dip coating method so as to provide a dried film thickness of 2 μm, whereby a surface coating material film was formed. Subsequently, using the curing apparatus illustrated in FIGS. 4A and 4B, the surface coating material film is irradiated with an ultraviolet ray as an actinic ray under the following irradiation conditions to cure the surface coating material film, whereby a surface layer was formed. Consequently, intermediate transfer belt 1 was manufactured. The irradiation with an ultraviolet ray of the surface coating material film was performed with a light source fixed, the PI belt, with the surface coating material film formed on the surface thereof, held on a cylindrical substrate and the cylindrical substrate rotated at 60 mm/s.

### (Coating Conditions)

Coating solution supply rate: 1 L/min

Pull-up speed: 4.5 mm/min

### (Ultraviolet Ray Irradiation Conditions)

Light source type: high-pressure mercury lamp (H04-L41 manufactured by Eye Graphics Co., Ltd.)

Distance from irradiation port to PI belt surface: 100 mm

Irradiation quantity: 1 J/cm²

Irradiation time (time during which the cylindrical substrate is rotated): 240 seconds

(Evaluation)

As characteristics of intermediate transfer belt 1 that substitute an actual durability thereof, a toner transfer ratio, a scratch resistance and a filming resistance of intermediate transfer belt 1 and a Si concentration at a certain depth from the surface of intermediate transfer belt 1 were measured.

(1) Toner Transfer Ratio

Intermediate transfer belt 1 was incorporated in the full-color image forming apparatus illustrated in FIG. 1, and an A4-size image with a cyan coverage rate of 100% was output on neutralized paper with an optimized light exposure and at 20° C./50% RH. In the present example, as the full-color image forming apparatus illustrated in FIG. 1, an apparatus obtained by altering bizhub PRO C6500 (laser-exposure, reversal development and intermediate transfer member-type tandem color multifunctional printer) manufactured by Konica Minolta Business Technologies, Inc. for evaluation of the intermediate transfer belt according to the example was used.

The light exposure in the evaluation printer was optimized, and intermediate transfer belt 1 was incorporated in the printer and an image with a coverage rate of 2.5% for each of respective colors, yellow (Y), magenta (M), cyan (C) and black (Bk) at 20° C./50% RH was printed on one million sheets of neutralized paper. The toner transfer ratio of intermediate transfer belt 1 after the printing was obtained by the following method.

Using a suction apparatus, toner on regions with a predetermined area of intermediate transfer belt 1 (three regions with 10 mm×50 mm) after primary transfer and before secondary transfer was collected, and weight (A) of toner before secondary transfer was measured.

Next, remaining toner on intermediate transfer belt 1 after secondary transfer was collected by a Booker tape, which was then adhered to a white sheet and the white sheet was subjected to color measurement using a spectrophotometer (CM-2002 manufactured by Konica Minolta Sensing, Inc.) and the weight (B) of the remaining toner was calculated based on the relationship measured in advance between the toner weight and the color measurement value.

Toner transfer ratio (n) was calculated according to the following equation:

η=(1−B/A)×100(%).

Then, based on the following criteria, the toner transfer ratio of intermediate transfer belt 1 was evaluated.

### (Toner Transfer Ratio Evaluation Criteria)

Excellent: toner transfer ratio equal to or larger than 98% and equal to or smaller than 100%
Good: toner transfer ratio equal to or larger than 95% and smaller than 98%
Fair: toner transfer ratio equal to or larger than 90% and smaller than 95%
Poor: toner transfer ratio smaller than 90%

(2) Scratch Resistance

Printing was performed on one million sheets by the same method as that of the toner transfer ratio evaluation, and the surface state of intermediate transfer belt 1 was observed before and after the printing to count scratches in a region of 100 mm×100 mm. Then, the scratch resistance of intermediate transfer belt 1 was evaluated based on the following criteria.

### (Scratch Resistance Evaluation Criteria)

Excellent: No scratch generated after the print of one million sheets
Good: one to five scratches generated after the print of one million sheets
Fair: six to ten scratches generated after the print of one million sheets
Poor: ten or more scratches generated after the print of one million sheets

(3) Filming Resistance

Printing was performed on one million sheets by the same method as that of the toner transfer ratio evaluation, and a color difference ΔE between the color of intermediate transfer belt 1 before and after the printing was determined. The color of intermediate transfer belt 1 was measured using a spectrophotometer (CM-2002 manufactured by Konica Minolta Sensing, Inc.). Then, the difference ΔE between color values before and after the printing was calculated. Based on the following criteria, the filming resistance of intermediate transfer belt 1 was evaluated. Favorable filming resistance means that a low surface free energy characteristic is provided.

### (Filming Resistance Evaluation Criteria)

Excellent: ΔE equal to or larger than 0 but smaller than 1
Good: ΔE equal to or larger than 1 but smaller than 4
Fair: ΔE equal to or larger than 4 but smaller than 6
Poor: ΔE equal to or larger than 6

(4) Si Concentration

A part of intermediate transfer belt 1 was cut out a piece so that each side of the piece has a length of around 10 mm to prepare a sample. A surface of the sample was dug for 50 seconds for each time under depth profiling conditions using Ar ions.

### (Depth Profiling Conditions (Ar Ions))

Digging time: 50 seconds/time

Accelerating voltage: 1,000 eV

Current: Low

Digging rate: 0.13 nm/second

Narrow spectral measurement (detected elements: C, O and Si) of the surface of the sample dug for T seconds by electron spectroscopy for chemical analysis (ESCA) under the following analysis conditions was carried out to determine the content percentage A2% of the silicon element at the created surface of the sample when the sample was dug to a depth of 2% relative to a total thickness of the sample, and content percentage A5% of the silicon element at the dug surface of the sample when the sample was dug to a depth of 5% relative to the total thickness of the sample. The content of the silicon element is a percentage of silicon atoms relative to a total number of atoms included in an object to be measured.

<ESCA Analysis Conditions>

Measuring apparatus: K-Alpha (manufactured by Thermo Fisher Scientific)

Measurement light source: Al (monochromator)

Beam diameter: 400 μm

Neutralization gun: ON

Spectrum: Narrow mode

Measured elements: C, O and Si

Pass energy: 50 eV

Stepsize: 0.1 eV

Digging time T was obtained from the digging rate. For example, under the above-indicated depth profiling conditions, if the total thickness of the sample is 2 μm, the depth of 2% relative to the total thickness is 0.04 μm and the depth of 5% is 0.10 μm. If the digging rate is 0.13 nm/second, time T for digging up to the depth of 2% relative to the total thickness is 307.7 seconds (corresponding to approximately six times of 50-second diggings).

Materials for surface coating material 1 that forms the surface layer of intermediate transfer belt 1, and results of evaluation of intermediate transfer belt 1 are indicated in Table 3 below.

### Examples 2 to 16

As indicated in Table 3 below, a procedure similar to that of example 1 was taken except that respective surface coating materials 2 to 16 were used instead of surface coating material 1 to manufacture respective intermediate transfer belts 2 to 16. Then, intermediate transfer belts 2 to 16 were evaluated in a manner similar to that of intermediate transfer belt 1. The type and materials of a surface coating material for each of intermediate transfer belts 2 to 16 and results of evaluation of the intermediate transfer belts are indicated in Table 3 below.

### Comparative Examples 1 and 4

As indicated in Table 3 below, surface coating materials 17 and 20 were each prepared instead of surface coating material 1. In surface coating material 17 and surface coating material 20, fine particles P-1 were not dispersed. Accordingly, neither manufacture of a surface layer using each of these surface coating materials nor evaluation of intermediate transfer belt was conducted. The type and materials of the surface coating material in each of comparative examples 1 and 4 are indicated in Table 3 below.

### Comparative Examples 2 and 3

As indicated in Table 3 below, a procedure similar to that of example 1 was taken except that surface coating materials 18 and 19 were each used instead of surface coating material 1 to manufacture intermediate transfer belts 18 and 19. Then, intermediate transfer belts 18 and 19 were evaluated in a manner similar to that of intermediate transfer belt 1. The type and material of the surface coating material in each of comparative examples 2 and 3 and results of evaluation of the intermediate transfer belts are indicated in Table 3 below.

TABLE 3

| | Surface layer | | | | | | | Evaluation results | | | | |
|---|---|---|---|---|---|---|---|---|---|---|---|---|
| | | | | | Content | | | | | | Si | |
| | Surface | Type | | | (parts by volume) | | | Toner | | | concentration | |
| | coating | | Fine | | | Fine | | transfer | Scratch | Filming | (%) | |
| | material | Polymer | particles | Monomer | Polymer | particles | Monomer | ratio | resistance | resistance | A2% | A5% |
| Example 1 | 1 | A-1 | P-1 | M-1 | 25 | 20 | 75 | Good | Good | Good | 5.5 | 5.0 |
| Example 2 | 2 | A-1 | P-2 | M-1 | 70 | 70 | 30 | Excellent | Good | Excellent | 10.0 | 9.0 |
| Example 3 | 3 | A-1 | P-4 | M-1 | 50 | 40 | 50 | Good | Excellent | Excellent | 6.0 | 5.4 |
| Example 4 | 4 | A-1 | P-7 | M-1 | 30 | 80 | 70 | Excellent | Good | Good | 8.0 | 7.9 |
| Example 5 | 5 | A-1 | P-10 | M-2 | 50 | 20 | 50 | Good | Fair | Good | 3.8 | 3.5 |
| Example 6 | 6 | A-2 | P-1 | M-1 | 10 | 20 | 90 | Good | Good | Good | 4.5 | 4.4 |
| Example 7 | 7 | A-2 | P-4 | M-1 | 25 | 60 | 75 | Excellent | Excellent | Good | 6.0 | 6.0 |
| Example 8 | 8 | A-2 | P-8 | M-1 | 60 | 50 | 40 | Good | Good | Excellent | 5.6 | 5.3 |
| Example 9 | 9 | A-2 | P-9 | M-1 | 5 | 15 | 95 | Good | Good | Excellent | 3.2 | 3.2 |
| Example 10 | 10 | A-3 | P-2 | M-1 | 40 | 25 | 60 | Good | Good | Good | 4.8 | 4.5 |
| Example 11 | 11 | A-3 | P-3 | M-1 | 25 | 30 | 75 | Good | Good | Excellent | 4.0 | 4.0 |
| Example 12 | 12 | A-3 | P-5 | M-1 | 50 | 30 | 50 | Good | Good | Good | 4.5 | 4.2 |
| Example 13 | 13 | A-4 | P-1 | M-1 | 10 | 50 | 90 | Excellent | Excellent | Excellent | 4.0 | 4.0 |
| Example 14 | 14 | A-4 | P-6 | M-1 | 40 | 90 | 60 | Excellent | Excellent | Good | 9.0 | 8.0 |
| Example 15 | 15 | A-5 | P-4 | M-1 | 45 | 30 | 55 | Excellent | Good | Excellent | 5.0 | 4.8 |
| Example 16 | 16 | A-5 | P-5 | M-1 | 30 | 25 | 70 | Good | Good | Excellent | 4.5 | 4.5 |
| Comparative | 17 | A-6 | P-1 | M-1 | 5 | 50 | 95 | No fine particles dispersed | | | | |
| example 1 | | | | | | | | | | | | |
| Comparative | 18 | A-1 | P-11 | M-1 | 25 | 40 | 75 | Fair | Good | Poor | 0.4 | 0.4 |
| example 2 | | | | | | | | | | | | |
| Comparative | 19 | A-1 | P-12 | M-1 | 25 | 40 | 75 | Fair | Excellent | Poor | 0.2 | 0.2 |
| example 3 | | | | | | | | | | | | |

| | | | | | | | | |
|---|---|---|---|---|---|---|---|---|
| Comparative | 20 | — | P-1 | M-1 | — | 20 | 100 | No fine particles dispersed |
| example 4 | | | | | | | | |

Each of intermediate transfer belts 1 to 16 according to examples 1 to 16 has a high toner transfer ratio and exhibits excellent scratch resistance. It can be considered that this is because the surface layer has an enhanced hardness as a result of addition of fine particles P. Furthermore, even after full-color print on one million sheets, the filming resistance was maintained. It can be considered that this is because the surface layer has low surface free energy due to polymer A containing silicone components.

Furthermore, in each of intermediate transfer belts 1 to 16, each of silicon concentration A2% at a depth of 2% of the thickness of the surface layer from the surface of the surface layer and silicon concentration A5% at a depth of 5% of the thickness of the surface layer from the surface of the surface layer are both values of several percents. In addition, the values of A2% and A5% are substantially equal to each other in each of the intermediate transfer belts. A reason why these silicon concentration results were obtained can be considered as follows.

Fine particles P have been surface-treated with a surface treating agent including the polyorganosiloxane chain B. Accordingly, fine particles P are evenly dispersed over the entire surface layer. Then, a solubility parameter value of the surface treating agent and a solubility parameter value of the silicone component in polymer A are close to each other. Thus, the silicone component in polymer A coats the surfaces of fine particles P in the surface coating material. Accordingly, the silicone component in polymer A is evenly dispersed over the entire surface layer.

As described above, it can be considered that in the surface layer, fine particles P surface-treated with the surface treating agent are coated with polymer A. Thus, it can be considered that even if the surface of the surface layer abrades away, the low surface free energy characteristic and the filming resistive characteristic are not lost, but maintained for a long period of time.

Meanwhile, each of intermediate transfer belts 18 and 19 according to comparative examples 2 and 3 using fine particles P-11 and P-12, respectively, exhibits generally favorable results in toner transfer ratio and scratch resistance. However, the filming resistance was insufficient. Each of A2% and A5% was 1/50 to 1/8 relative to the above-described examples.

In general, silicone components in a surface coating material tend to be localized exist on the surface of a surface coating material film. However, the silicone component in polymer A described above in the present invention exhibit an excellent affinity to the silicone component used as a surface treating agent for a filler to be surface-treated. Thus, the silicone component in polymer A collect on the surface of the filler surface-treated with a surface treating agent including the polyorganosiloxane chain B, and the silicone component in polymer A is evenly dispersed over the surface layer together with the surface-treated filler. As described above, an intermediate transfer belt according to the present invention enables silicone components in both of a surface-treated filler and a resin component to be evenly dispersed in the surface layer, and thus, high hardness and low surface energy can be maintained at the surface layer for a long period of time, enabling achievement of a high toner transfer ratio, high scratch resistance and high filming resistance. Therefore, an intermediate transfer belt according to the present invention can be expected to contribute to development, diffusion and progression of electrophotographic image forming apparatuses that form high-quality images over a long period of time.

What is claimed is:

1. An intermediate transfer member for use in an electrophotographic image forming apparatus, the intermediate transfer member comprising a substrate and a surface layer disposed on the substrate,
wherein the surface layer is a cured coat of a coating solution for surface layer, the coating solution containing an actinic ray-curable composition and metal oxide fine particles, the coat cured by irradiation with an actinic ray,
wherein the actinic ray-curable composition contains: a vinyl copolymer with a weight-average molecular weight of 5,000 to 100,000, the vinyl copolymer including at least one polyorganosiloxane chain A and at least three radically-polymerizable double bonds; and a multifunctional (meth)acrylate, and
wherein the metal oxide fine particles are surface-treated with a surface treating agent including a polyorganosiloxane chain B.

2. The intermediate transfer member according to claim 1, wherein a Si concentration at a depth of 2 to 5% of a total thickness of the surface layer from a surface of the surface layer is 1 to 10%.

3. The intermediate transfer member according to claim 1, wherein a content of the metal oxide fine particles is 10 to 100 parts by volume per 100 parts by volume of the actinic ray-curable composition.

4. The intermediate transfer member according to claim 1, wherein a content of the vinyl copolymer is 5 to 75 parts by volume per 100 parts by volume of the actinic ray-curable composition.

5. The intermediate transfer member according to claim 1, wherein the multifunctional (meth)acrylate includes urethaneacrylate.

6. The intermediate transfer member according to claim 1, wherein the metal oxide fine particles are surface-treated with a single end-modified silicone oil.

7. The intermediate transfer member according to claim 1, wherein the metal oxide fine particles are made of alumina.

8. The intermediate transfer member according to claim 1, wherein the metal oxide fine particles are made of tin oxide.

9. The intermediate transfer member according to claim 1, further comprising a layer including an elastic material between the substrate and the surface layer.

10. The intermediate transfer member according to claim 1, further comprising a layer including an elastic material between the substrate and the surface layer,
wherein the elastic material contains a material having elasticity from among the materials of the surface layer.

11. The intermediate transfer member according to claim 1, wherein the substrate is an endless belt.

12. An image forming apparatus comprising the intermediate transfer member according to claim 1.
